(19) United States
(12) Patent Application Publication
(10) Pub. No.: US 2008/0247806 A1
(43) Pub. Date: Oct. 9, 2008

(54) Applicator Device

(75) Inventors: Catherine Henwood Todd, Whitefish, MT (US); Andrew Clair Seys, Scottsdale, AZ (US); Mark D. Hannen, Scottsdale, AZ (US); E. Gary Myers, Scottsdale, AZ (US); Jim F. Warner, Westfield, NJ (US)

Correspondence Address: SNELL & WILMER, LLP (Dial Corp), ONE ARIZONA CENTER, 400 E. VAN BUREN, PHOENIZ, AZ, 85004-2202, US

(73) Assignee: THE DIAL CORPORATION, Scottsdale, AZ (US)

(21) Appl. No.: 10/598,828

(22) PCT Filed: Mar. 15, 2005
(86) PCT No.: PCT/US2005/008436

§ 371 Date: Jun. 11, 2008

Related U.S. Application Data
(60) Provisional application No. 60/553,780, filed on Mar. 16, 2004.

(51) Int. Cl. B05C 17/005; A47K 7/02

(52) U.S. Cl. 401/205; 15/244.4

(57) ABSTRACT

The present invention provides an applicator including a combination applicating device (110) and substance (120) to be applied. For example, the applicator is particularly suited to the application of liquids integrated with a sponge or sponge-like device. In such personal cleansing environments, the liquid is associated with the sponge, and by activating the sponge (e.g., squeezing it), a dose of liquid is distributed to the sponge matrix, and the applicator can be used to apply the liquid to a surface.

### FIELD OF INVENTION

This invention relates generally to applicator devices, and more particularly, to applicator devices for dispensing and applying cleansing liquids, such as soaps.

### BACKGROUND OF THE INVENTION

Various liquids, particularly cleaning products such as detergents, cleansers, and personal care products have historically not been integrated with the devices used to apply these products. For example, personal care cleansing products are traditionally provided as bottled liquids and creams, or in bar form. Bottled liquids, such as bodywashes and gels, are often applied to a separate sponge, washcloth, or “pouf” at the time of use. Similarly, bar soaps and the like are likewise separately applied to an applicator or to the user's body and, after application, scrubbed and/or rinsed off.

However, consumers increasingly desire personal care products that are reusable, convenient, simple, and effective. For example, consumers desire products which variously stimulate the skin, offer deep cleaning, are mild, exfoliate, moisturize, as well as numerous other characteristics and combinations of these characteristics. Additionally, consumers desire products which have the appearance of an innovative approach to personal hygiene.

### SUMMARY OF THE INVENTION

While the way in which the present invention addresses the disadvantages of the prior art is discussed in greater detail below, in general, the present invention provides an applicator including a combination applicating device and substance to be applied. In accordance with various embodiments of the present invention, the applicator is particularly suited to the application of liquids integrated with a sponge or sponge-like device. As used herein, the term “sponge” should be understood to refer generally to the applicator, such applicator generally comprising a porous, water insoluble material capable of distributing a substance such as a bodywash. Thus, in this sense, the term “sponge” includes the traditional meaning of a sponge for cleansing, but likewise may include other known or as yet unknown devices such as cloths and “poufs.” In such personal cleansing environments, a liquid (e.g., bodywash, gel, and the like) is associated with the sponge, and by activating the sponge (e.g., squeezing it), a dose of liquid is distributed to the sponge matrix, and the applicator can be used to apply the liquid

As such, an applicator in accordance with the present invention includes an applicating device, the applicating device comprising a substantially water insoluble material at least partially enclosing an outer surface of a liquid storage volume, the liquid storage volume containing a liquid to be applied, and a one-way valve connected to the liquid storage volume. In various embodiments, the liquid storage volume is comprised of a material to which the liquid is impermeable. In accordance with various embodiments of the present invention, the one-way valve dispenses a pre-determined dose of the liquid contained therein.

In various embodiments in accordance with the present invention, the one-way valve is further connected to the applicating device and/or to an environment external to the applicating device. Additionally, in various embodiments, the applicator further includes a liquid exit port connecting an outer surface of the applicating device and the one-way valve.

In accordance with various embodiments of the present invention, the applicating device is a sponge and may further include first and second portions attached to each other at an outer periphery of each. Alternatively, the first and second portions may be attached by a netting configured as a bag to hold the first and second portions together.

In accordance with various other embodiments of the present invention, the applicator further includes a surface enhancer on an outer surface of the applicating device which, in various embodiments, may be a mesh netting, cloth, or other material. As will be discussed herein, numerous advantages of the present invention may be realized in its various embodiments.

### BRIEF DESCRIPTION OF THE DRAWINGS

The subject matter of the present invention is particularly pointed out and distinctly claimed in the concluding portion of the specification. A more complete understanding of the present invention, however, may best be obtained by referring to the detailed description and claims in connection with the drawing figures, wherein:

FIG. 1 is a block diagram illustrating an exemplary embodiment of an applicator device in accordance with the present invention;

FIG. 2 is a block diagram illustrating another exemplary embodiment of an applicator device in accordance with the present invention;

FIG. 3 is a block diagram illustrating yet another exemplary embodiment of an applicator device in accordance with the present invention;

FIG. 4a is a cross-sectional front view of an exemplary embodiment of a personal cleansing device in accordance with the present invention;

FIG. 4b is a top view of the personal cleansing device of FIG. 4a;

FIG. 4c is a cross-sectional side view of the personal cleansing device of FIG. 4a;

FIG. 4d is a front view of the personal cleansing device of FIG. 4a;

FIG. 4e is a cross-sectional top view of the personal cleansing device of FIG. 4a;

FIG. 5 is a perspective view of an alternative exemplary embodiment of a personal cleansing device in accordance with the present invention; and

FIG. 6a-c are cross-sectional side views of the personal cleansing device of FIG. 5 in use.

### DETAILED DESCRIPTION

The following description is of exemplary embodiments of the invention, and does not limit the scope, applicability, or configuration of the invention in any way. Rather, the following description is intended to provide a convenient illustration for implementing various embodiments of the invention. As will become apparent, various changes may be made to the function and arrangement of the elements described in these embodiments without departing from the spirit and scope of the invention as set forth in the appended claims. For example, in the context of the present invention, an applicator is described herein with reference to particular shapes (e.g., as shown in the Figures), however, the applicator may have numerous shapes and configurations depending upon its particular use. Likewise, though the applicator is described herein largely in connection with personal care uses, notably bodywash application, the application may be adapted for various other uses and substances as well.. For example, the applicator may find use in many different fields, such as various household (washing dishes, general cleaning, etc.) and commercial (washing/maintaining machinery, equipment, vehicles, etc.) environments. As such, terms in the following description should not generally be used to limit the applicator to personal care related uses or substances.

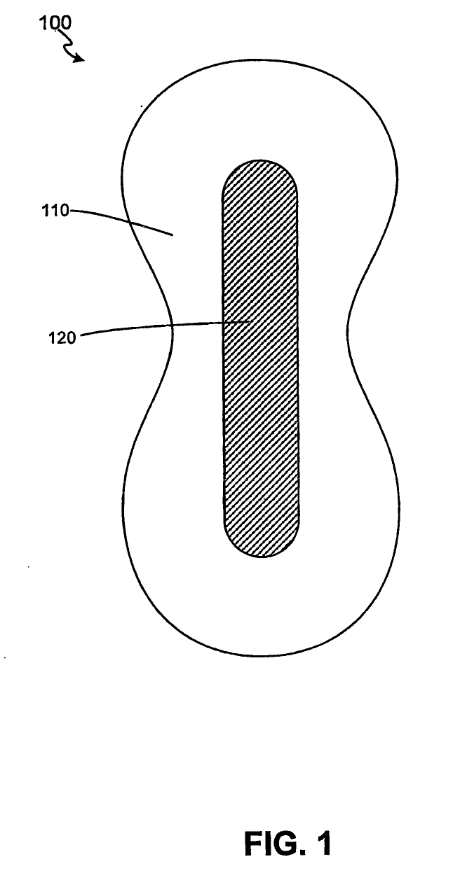

Turning now to the Figures, FIG. 1 is a block diagram of an exemplary embodiment of an applicator 100 in accordance with the present invention. In one exemplary embodiment, applicator 100 includes application matrix 110 in communication with a liquid 120 to be dispensed. For example, and in accordance with various embodiments of the present invention, upon activation (e.g., squeezing) of applicator 100, liquid 120 is transmitted to application matrix 110, and application matrix 110 is used to apply liquid 120.

In various embodiments, application matrix 110 is in physical communication with a reservoir 130 containing liquid 120 via, for example, contact between the two and/or by a liquid transport mechanism 140. In this context, briefly, reservoir 130 may be any suitable volume capable of containing liquid 120. For example, reservoir 130 may be a cavity formed in application matrix 110. Alternatively, reservoir 130 may comprise a containment vessel (e.g., a bottle, pouch, and the like) configured as a distinguishable component of applicator 100, preferably, comprised of a material impermeable to liquid 120.

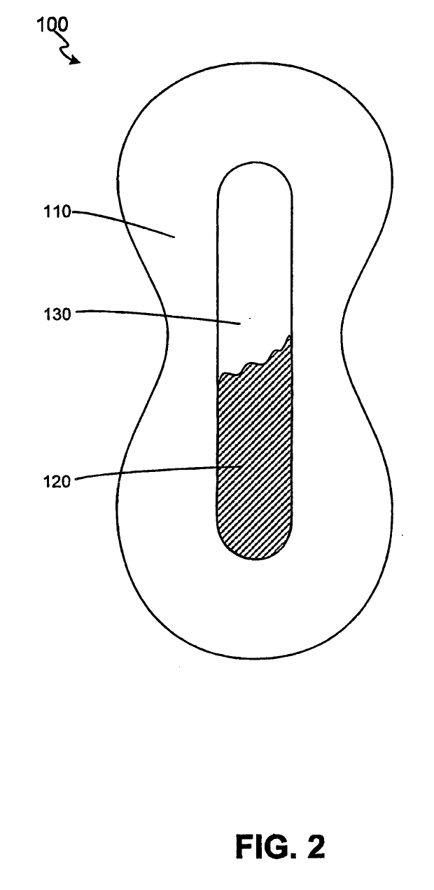

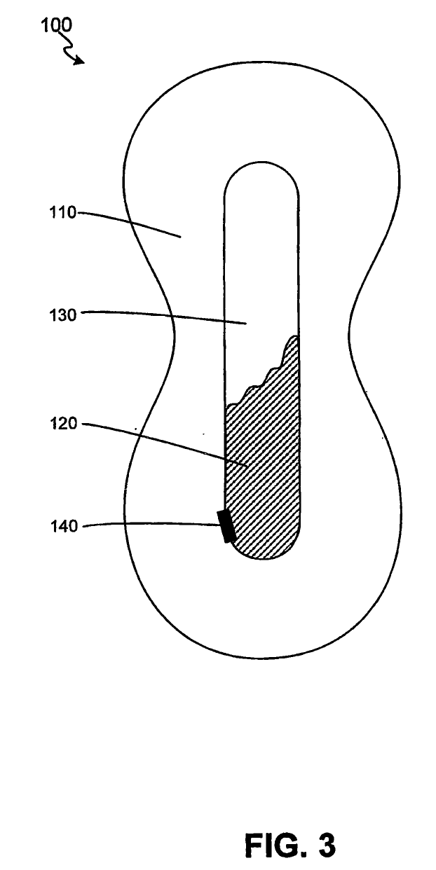

With reference to FIG. 2, in various exemplary embodiments, reservoir 130 is adjacent to application matrix 110. Alternatively, with reference to FIG. 3, reservoir 130 is contained within application matrix 110. Moreover, as should be appreciated by one skilled in the art, any number of configurations of reservoir 130 and application matrix 110 which facilitate contact and/or transmission of liquid 120 from reservoir 130 to application matrix 110 are possible, for example, where reservoir 130 is partially enclosed within application matrix 110.

In accordance with various exemplary embodiments of the present invention, transport mechanism 140 provides for the movement of liquid 120 to application matrix 110. For example, with reference to FIGS. 2 and 3, is an area between application matrix 110 and liquid 120 through which liquid 120 may pass to application matrix 110. Thus, transport mechanism 140 may include a passageway between application matrix 110 and/or reservoir 130. Alternatively, transport mechanism 140 may include a gate (e.g., a valve) having OPEN and CLOSED positions selectively capable of distributing liquid 120. Further, while in the present description transport mechanism 140 is illustrated as contained inside an outer surface of application matrix 110, it should be appreciated that in various alternative embodiments, transport mechanism 140 may transmit liquid 120 directly to the outer surface of application matrix 110. Additionally, in various embodiments, transport mechanism 140 provides the ability to meter the amount of liquid 120 exiting reservoir 130 at a given time. In such embodiments, depending upon the total amount of liquid 120 provided and the amount distributed during each use, applicator 100 may have more than one use and, therefore, be reusable. Additionally, as will also be described below, various embodiments of the present invention provide the ability to replenish the volume of liquid 120 in applicator 100 after it has been depleted.

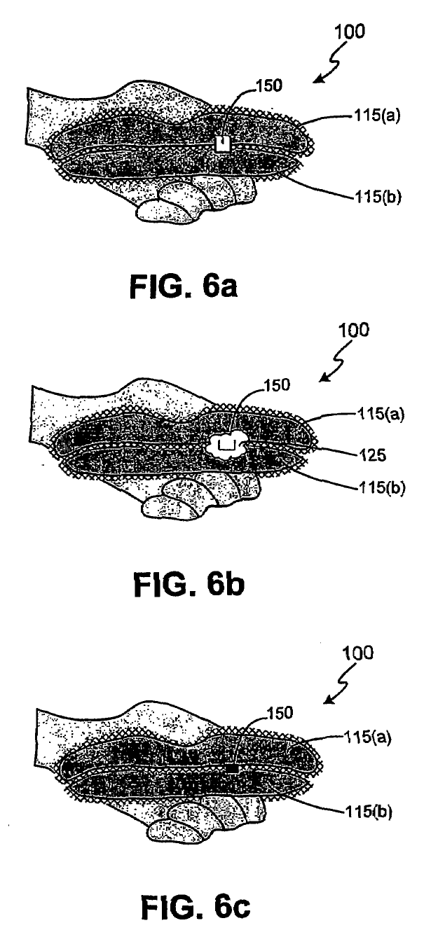

Now, as discussed above, applicator 100 is particularly suited for applying liquids, such as a bodywash, by integrating an application matrix, such as a sponge or sponge-like device, wherein the sponge is a porous matrix capable of temporarily containing the bodywash until application, and a reservoir for holding the bodywash, such as a pouch. In personal cleansing environments, and referring briefly to FIGS. 6a-c, a bodywash 125 is associated with a sponge 115, and by activating sponge 115 (e.g., squeezing it), a dose of bodywash 125 is distributed to sponge 115, and applicator 100 can be used to apply bodywash 125 to a surface.

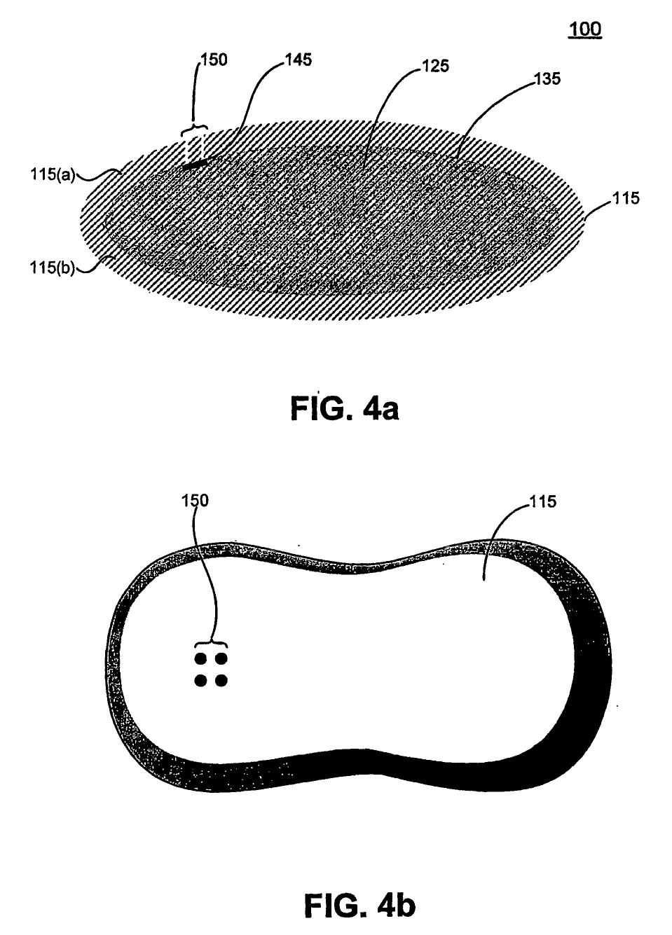

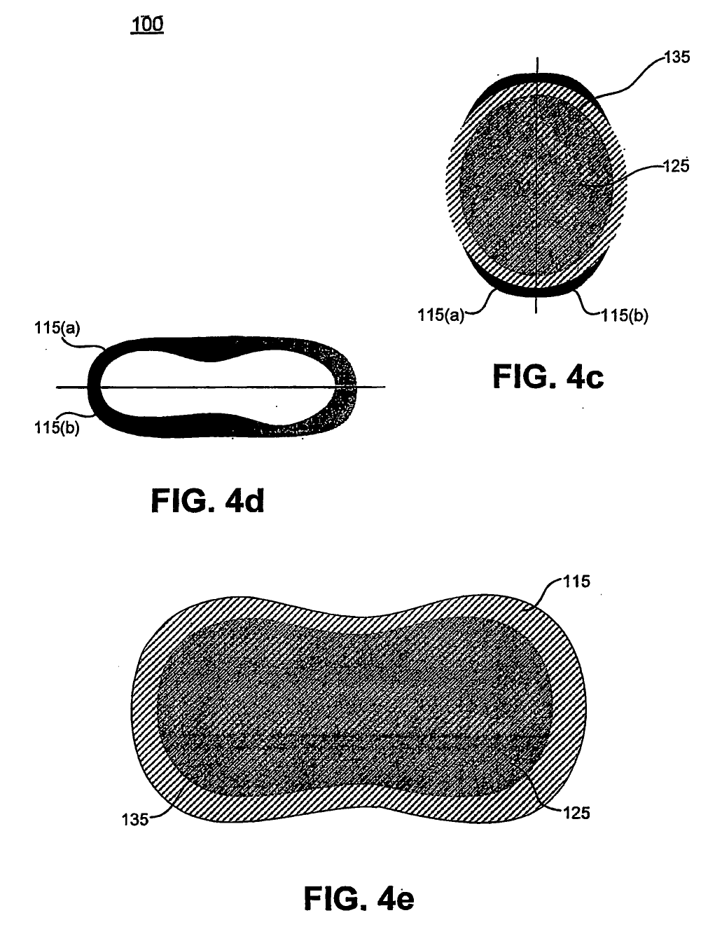

For example, with reference now to FIGS. 4a-e, applicator 100 is described in the context of a bodywash applicator. Applicator 100, in an exemplary embodiment, includes an application matrix as an elastically deformable, at least semi-porous material, such as sponge 115. Sponge 115 is preferably configured to have and ergonomical shape to fit the contour of an average human hand. For example, a preferable shape is an “hourglass” design with a long axis of about five inches to about six inches, a thickness if about two inches to about three inches, a major width (widest portion) of about three inches to about four inches, and a minor width (narrowest portion measured at an approximate center) of about two and a half inches to about three inches, with a gentle taper from the minor width to the major width.

In another exemplary embodiment, disposed within sponge 115 is a pouch 135 containing a bodywash 125. Preferably, pouch 135 is a deformable pouch comprised of a material impermeable to bodywash 125, such as plastic, foil, or other functionally similar material now known or as yet unknown in the art. For example, pouch 135 may be a pouch manufactured by KAPAK Corporation of Minnesota or Polyworks LLC of Rhode Island.

In the presently described embodiment, pouch 135 further includes a transport mechanism configured as a valve 145 between pouch 135 and sponge 115 to permit transport of bodywash 125 from pouch 135 to an outer surface of sponge 115. Preferably, valve 145 is configured to allow the passage of bodywash 125 upon user activation (described below), but after initial activation and bodywash 125 dispensation, prevent further distribution of bodywash 125 and prevent bodywash 125 and/or any other material from re-entering pouch 135. Valves having such capabilities are referred to herein as “one-way” valves. Moreover, preferably, in various embodiments, valve 145 is metered to dispense a pre-determined amount of bodywash 125. Valves having such metering capabilities are referred to herein as “metered” valves. For example, in the presently described embodiment, valve 145 is a one-way, metered valve which distributes about 1.5 grams of bodywash 125 for each activation.

Additionally, in accordance with various embodiments of the present invention, by metering bodywash 125 through sponge 115, smaller amounts of bodywash 125 are necessary to achieve similar results relative to conventional bodywash techniques that may require greater amounts of bodywash 125. Similarly, using concentrated bodywash formulas within pouch 135 means less bodywash 125 is needed to achieve results comparable to conventional bodywash formulas. As such, in various embodiments of applicator 100, pouch 135 need not contain large amounts of bodywash 125 to obtain “number of use” and efficacy characteristics similar to industry standard bodywash bottles.

Additionally, with reference again to FIGS. 6am, in one exemplary embodiment, a first squeeze of applicator 100 opens valve 145 (not shown), to allow distribution of bodywash 125 via a portal 150. In various embodiments, the distribution may be continuous until a second squeeze is applied to close valve 145. Thus, after an initial squeeze, one may apply bodywash 125 and deactivate after use, or alternatively, squeeze twice consecutively to distribute one “dose” and then apply bodywash 125.

It should be appreciated, of course, that various bodywash compositions may require differing amounts to be distributed for optimal efficacy. As such, varying amounts to be metered may be pre-determined and/or multiple activations of valve 145 may be required during one actual use. Similarly, in the context of non-personal care type applications, different amounts of a liquid to be dispensed may likewise be required, and alternative metering numbers and/or valve 145 activation may be required. Nonetheless, such amounts still fall within the ambit of the present invention.

In accordance with further aspects of the present invention, a portal 150 may be provided to facilitate transport of bodywash 125 to an external surface of sponge 115. For example, with reference to FIG. 4b, four portals 150 are provided as tubular formations between the outer surface of sponge 115 and valve 145. It should be appreciated, of course, that any number of portals 150, if any, may be used in accordance with the present invention depending on the particular application and desired characteristics.

In accordance now with another aspect of the presently described embodiment, sponge 115 further comprises an upper (first) portion 115a and a lower (second) portion 115b. Upper and lower portions 115a, b are suitably deposed opposite one another and, in various embodiments, define a cavity (not shown) enclosing pouch 135. However, in various alternative embodiments, the elastic nature of the material of sponge 115 may provide for the ability to enclose pouch 135 without pre-defining a cavity and additionally provide advantages such as continuous pressure exerted on pouch 135, thereby facilitating dispensation of bodywash 125.

In this embodiment, upper and lower portions 115a, b are preferably maintained around pouch 135. For example, in one embodiment, upper and lower portions 115a, b are attached at a peripheral edge of each, wherein, the peripheral edges may be sewn, glued, heat fused, or attached by other suitable mechanism or means now known or as yet unknown in the art.

In accordance now with another aspect of the presently described embodiment, application 100 further includes a surface enhancer 160 on the outer surface of sponge 115. In general, surface enhancer 160 is any surface characteristic which provides functional change to the surface of sponge 115. For example, sponge 115 may have one or more raised or indented features on its exterior surface. Such features suitably provide control over the texture, feel and cleansing characteristics of sponge 115. For example, in the context of personal care, raised ribs or dimples may provide scrubbing benefits, exfoliation, and/or epidermal massage. Similarly, in the context of general cleaning, surface enhancers may provide abrasion benefits.

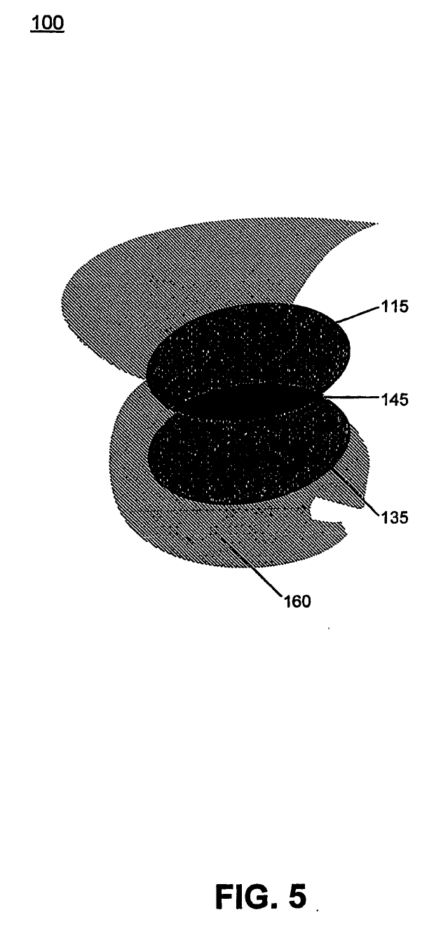

In one embodiment, as is illustrated in FIG. 5, surface enhancer 160 includes a mesh netting covering at least a portion of the outer surface of sponge 115, preferably, proximate to valve 145 and/or portal(s) 150. In the present embodiment, surface enhancer 160 is comprised of nylon string although other materials are contemplated. The mesh pattern may thus provide benefits such as those mentioned above. It should thus be appreciated, however, that surface enhancer 160 may comprise numerous different configurations of numerous different materials and still fall within the ambit of the present invention. For example, various cloth coverings may be used as surface enhancer 160.

In various other embodiments, surface enhancer 160 may also entirely envelop sponge 115. For example, surface enhancer 160 may comprise a bag or tube-like configuration into which sponge 115 is placed. Such embodiments may be particularly advantageous in providing the attachment mechanism in embodiments having, for example, more than one sponge or sponge portions. For example, in connection with the embodiment described immediately above wherein sponge 115 comprises upper and lower portions 115a,b, a bag-type, mesh netting surface enhancer 160 suitably maintains portions 115a,b together. Additionally, surface enhancer 160 may be configured to be removable so that pouch 135 maybe refilled or replaced, extending the life of applicator 100. Additionally, different bag-type devices having varying textures and characteristics may be substituted.

Various principles of the invention have been described in illustrative embodiments, however, many combinations and modifications of the above-described structures, arrangements, proportions, elements, materials, and components used in the practice of the invention, in addition to those not specifically described, may be varied and particularly adapted to specific environments and operating requirements without departing from those principles.

1. An applicator (100) to cleanse a surface, comprising:
a matrix material (110), wherein said matrix material is comprised of a substantially water insoluble material and forms a shape;
a cavity formed in said matrix material;
a reservoir (130) occupying at least a portion of said cavity; and
a valve (140) associated with said reservoir, wherein said valve is configured to control the distribution of liquid from said reservoir.

2. The applicator of claim 1, wherein said reservoir is comprised of a liquid impermeable material.

3. The applicator of claim 1, wherein said reservoir is one of replaceable and refillable.

4. The applicator of claim 1, wherein said matrix material is one of a sponge (115) and a pouf.

5. The applicator of claim 1, wherein said matrix material is a sponge comprising a first portion (115a) and a second portion (115b), and said first portion of said sponge comprises a first portion of said cavity and said second portion of said sponge comprises a second portion of said cavity, the applicator further comprising:
a netting (170) configured to hold said first portion of said sponge and said second portion of said sponge together such that said first portion of said cavity and said second portion of said cavity are combined to form said cavity.

6. The applicator of claim 1, wherein said valve is a one-way, metered valve.

7. The applicator of claim 1, wherein said value is configured to distribute a continuous supply of said liquid from said reservoir when the applicator is activated a first time, and cease distributing a continuous supply of said liquid from said reservoir when the applicator is activated a second time.

8. The applicator of claim 1, wherein said valve is configured to distribute a pre-determined amount of said liquid each time the applicator is activated.

9. The applicator of claim 1, further comprising:
one or more portals (150) formed in said matrix material, wherein said one or more portals associates an outer surface of said matrix material and said valve.

10. The applicator of claim 1, further comprising:
one of a cleansing liquid (120) and a body wash (125) occupying at least a portion of said reservoir.

11. The applicator of claim 1, further comprising:
a surface enhancer (160) covering at least a portion of an outer surface of said matrix material.
